(19) United States
(12) Patent Application Publication
(10) Pub. No.: US 2015/0151350 A1
(43) Pub. Date: Jun. 4, 2015

(54) PRESS SYSTEM AND VACUUM SYSTEM THEREFOR

(71) Applicant: STOLLE MACHINERY COMPANY, LLC, Centennial, CO (US)

(72) Inventors: AARON E. CARSTENS, CENTERVILLE, OH (US); JASON A. DAVIDSON, SIDNEY, OH (US)

(73) Assignee: STOLLE MACHINERY COMPANY, LLC, Centennial, CO (US)

(21) Appl. No.: 14/093,979

(22) Filed: Dec. 2, 2013

(51) Int. Cl. B21D 43/18; B65G 15/58; B21D 51/38

(52) U.S. Cl. CPC B21D 43/18; B21D 51/383; B65G 15/58

(57) ABSTRACT

A vacuum system for a press system is provided. The press system includes a die assembly, a supply assembly, and a transfer assembly. The vacuum system includes an airflow generator and a duct assembly. The duct assembly includes a primary duct that includes a coupling segment coupled to and in fluid communication with the airflow generator. The duct assembly further includes a plurality of branch assemblies, each including a first portion extending from and being in fluid communication with the primary duct, and a second portion structured to be in fluid communication with a corresponding portion of said press system. The vacuum system further includes a number of baffle assemblies for controlling the airflow, each baffle assembly being disposed on one of the branch assemblies.

### BACKGROUND

1. Field

The disclosed concept pertains generally to press systems and, in particular, to press systems such as, for example, conversion presses. The disclosed concept also pertains to vacuum systems for press systems.

2. Background Information

Press systems, such as for example, conversion presses, are used in the can-making industry to form (e.g., convert and finish) partially formed ends or shells into fully finished can ends or lids such as, for example, easy open ends (EOEs) for food or beer/beverage containers.

Typically, the shells enter the press on a conveyor belt where they are progressively formed by a number of die assemblies. It is necessary to establish and maintain the desired position of the shells throughout the loading and metal forming processes in the press system, in order to properly form the EOEs. Some press systems employ vacuum systems to provide vacuum pressure to hold and maintain the shells during these processes. Known vacuum systems provide relatively large volumetric flow rates, but have undue flow restrictions and require excessive maintenance. Consequently, these systems are inefficient at generating desirable levels of vacuum pressure.

FIG. 1 shows an example vacuum system 100 for a press system 2 (partially shown). The vacuum system 100 includes an airflow generator 110 structured to provide vacuum pressure at various locations within the press system 2. Airflow generator 110 is coupled to a conduit 112 having a diameter 114 between 2.5 inches and 3 inches. Conduit 112 terminates at a vacuum box 116 that includes a filter assembly 118 and a vacuum relief valve 119 (shown in FIG. 2) integral to the filter assembly 118. The vacuum relief valve 119 is adjustable (i.e., movable between the open position, shown, in which it allows air to escape from the vacuum system 100 through hole 121, and a closed position). This is the sole means for adjusting vacuum pressure provided by the airflow generator 110.

The vacuum box 116 is further coupled to a pair of conduits 120,122 (e.g., flexible hoses), each of which have a diameter 124 of about 2 inches. The conduits 120,122 terminate at a pair of die ports 126,128 that are coupled to a die assembly 130 of the press system 2. The die assembly 130 is where the metal forming operations are performed on the shells/ends.

The vacuum system 100 employs additional separate airflow generators 140,170, seen in FIGS. 3 and 4 respectively, to provide vacuum pressure to various areas of the press system 2. Referring to FIG. 1, the airflow generator 140 is coupled to a pair of conduits 142,144 that terminate at a pair of downstacker ports 146,148. The airflow generator 140 provides vacuum pressure to the downstackers that feed shells into the press system 2. Continuing to refer to FIG. 1, the third airflow generator 170 (shown in FIG. 4) is coupled to a pair of conduits 172,174 that terminate at a pair of die ports 176,178 that are coupled to the die assembly 130. The airflow generators 140,170 provide vacuum pressure for the press system 100 in the same manner as the airflow generator 110.

As seen, the vacuum system 100 redundantly employs three separate airflow generators 110,140,170 to provide vacuum pressure at the die ports 126,128,176,178 and the downstacker ports 146,148. Similar press systems (not shown) also require multiple airflow generators to provide vacuum pressure. Furthermore, the main mechanism for pressure control within the vacuum system 100 is vacuum relief valves (see, for example vacuum relief valve 120), which inefficiently allow air to escape from the vacuum system 100.

There is, therefore, room for improvement in press systems and in vacuum systems therefor.

### SUMMARY

These needs and others are met by embodiments of the disclosed, which is directed to a vacuum system for a press system, which among other benefits more efficiently delivers vacuum to an entire press system with a single airflow generator.

In accordance with one aspect of the disclosed concept, a vacuum system for a press system is provided. The press system includes a die assembly, a supply assembly, and a transfer assembly. The vacuum system includes an airflow generator and a duct assembly. The duct assembly includes a primary duct that includes a coupling segment coupled to and in fluid communication with the airflow generator. The duct assembly further includes a plurality of branch assemblies, each including a first portion extending from and being in fluid communication with the primary duct, and a second portion structured to be in fluid communication with a corresponding portion of said press system. The vacuum system further includes a number of baffle assemblies for controlling the airflow, each baffle assembly being disposed on one of the branch assemblies.

As another aspect of the disclosed concept, a press system is provided. The press system includes a die assembly; a supply assembly; a transfer assembly including a conveyor belt and a vacuum manifold coupled to the die assembly; and a vacuum system. The vacuum system includes an airflow generator and a duct assembly. The duct assembly includes a primary duct that includes a coupling segment coupled to and in fluid communication with the airflow generator. The duct assembly further includes a plurality of branch assemblies, each including a first portion extending from and being in fluid communication with the primary duct, and a second portion structured to be in fluid communication with a corresponding portion of said press system. The vacuum system further includes a number of baffle assemblies for controlling the airflow, each baffle assembly being disposed on one of the branch assemblies.

### BRIEF DESCRIPTION OF THE DRAWINGS

A full understanding of the disclosed concept can be gained from the following description of the preferred embodiments when read in conjunction with the accompanying drawings in which:

FIG. 1 is a top plan view of a portion of a prior art press system;

FIG. 2 is a top plan view of a vacuum relief valve of the press system of FIG. 1;

FIG. 3 is a side elevation view of a portion of the press system and vacuum system therefor of FIG. 1;

FIG. 4 is a side elevation view of another portion of the press system and vacuum system therefor of FIG. 1;

FIG. 5 is an isometric view of a portion of a vacuum system in accordance with an embodiment of the disclosed concept;

FIG. 6 is a top plan view of the vacuum system of FIG. 5 shown as employed on a portion of a press system;

FIG. 7 is a top plan view of a portion of the press system and vacuum system therefor of FIG. 6;

FIG. 8 is a side elevation view of the portion of the press system and vacuum system therefor of FIG. 6; and

FIG. 9 is a graph showing power output and corresponding volumetric flow of an airflow generator within the press system of FIG. 1.

### DESCRIPTION OF THE PREFERRED EMBODIMENTS

It will be appreciated that the specific elements illustrated in the Figures herein and described in the following specification are simply exemplary embodiments of the disclosed concept, which are provided as non-limiting examples solely for the purpose of illustration. Therefore, specific dimensions, orientations and other physical characteristics related to the embodiments disclosed herein are not to be considered limiting on the scope of the disclosed concept.

Directional phrases used herein, such as, for example, top, closer, and derivatives thereof, relate to the orientation of the elements shown in the drawings and are not limiting upon the claims unless expressly recited therein.

As employed herein, the terms “can” and “container” are used substantially interchangeably to refer to any known or suitable container, which is structured to contain a substance (e.g., without limitation, liquid; food; any other suitable substance), and expressly includes, but is not limited to, beverage cans, such as beer and soda cans, as well as food cans.

As employed herein, the term “can end” refers to the lid or closure that is structured to be coupled to a can, in order to seal the can.

As employed herein, the term “shell” is used interchangeably with the term “can end.” The “shell” the member that is acted upon and is converted by the disclosed tooling to provide the desired can end.

As employed herein, the statement that two or more parts are “coupled” together shall mean that the parts are joined together either directly or joined through one or more intermediate parts.

As employed herein, the term “number” shall mean one or an integer greater than one (i.e., a plurality).

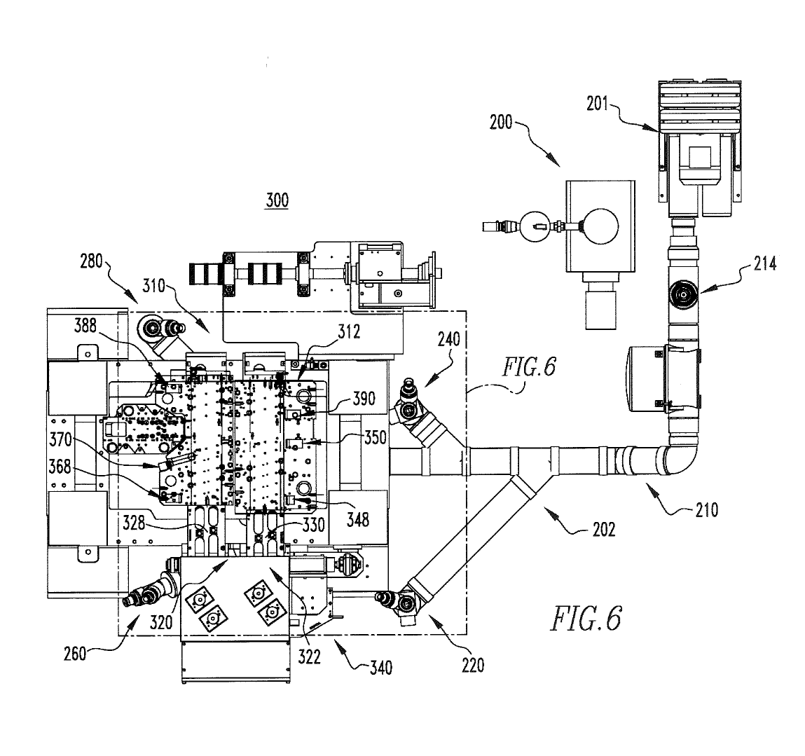

FIG. 5 shows a portion of a vacuum system 200 that may be used with a press system (e.g., without limitation, conversion press 300, partially shown in FIGS. 6, 7 and 8). As seen in FIG. 5, the vacuum system 200 includes an airflow generator 201 (e.g., without limitation, regenerative blower) and a duct assembly 202 coupled to the airflow generator 201. The duct assembly 202 includes a primary duct 210 and a number of branch assemblies 220,240,260,280 coupled to and in fluid communication with the primary duct 210. The primary duct 210 includes a coupling segment 212 that is coupled to the airflow generator 201 and a check valve 214 located near the coupling segment 212. The check valve 214 is adapted to only open when the vacuum system 200 is clogged or otherwise blocked downstream, for example, by debris. Thus, the check valve 214 advantageously operates as a safety mechanism for the vacuum system 200.

Each of the branch assemblies 220,240,260,280 includes a corresponding first portion 222,242,262,282 that extends from and is in fluid communication with the primary duct 210, a second portion 224,244,264,284 that is in fluid communication with a corresponding portion of the conversion press 300 (FIGS. 6, 7 and 8), and an airflow splitter member 226,246,266,286. It will be appreciated that although the vacuum system 200 includes four branch assemblies 220,240,260,280, it is within the scope of the disclosed concept for a vacuum system (not shown) to include any suitable alternative number of branch assemblies (not shown).

Referring to the first branch assembly 220, the airflow splitter member 226 includes a first branch 228, a second branch 230, and a third branch 232. In operation, air flows from the first and second branches 228,230 into the third branch 232. In a similar manner, the airflow splitter members 246,266,286 each include corresponding first and second branches 248,250,268,270,288,290 and in operation, air flows from the first and second branches 248,250,268,270,288,290 into corresponding third branches 252,272,292. As such, each branch assembly 220,240,260,280 delivers vacuum to multiple locations on the conversion press 300 (FIGS. 6, 7 and 8).

Continuing to refer to FIG. 5, the first branch assembly 220 includes a duct 238 coupled to and in fluid communication with the first portion 222 and the second portion 224 of the first branch assembly 220. Additionally, the vacuum system 200 includes a baffle assembly 203 located on the first branch assembly 220. The baffle assembly 203 includes a blast gate 205 that directs and controls airflow from the first and second branches 228,230 of the airflow splitter member 226 into the duct 238.

In a similar manner, the second branch assembly 240 includes a duct 258 coupled to and in fluid communication with the first and second portions 242,244 of the second branch assembly 240. The vacuum system 200 includes another baffle assembly 204 located on the second branch assembly 240. The baffle assembly 204 includes a blast gate 206 that directs and controls airflow from first and second branches 248,250 of the airflow splitter member 246 into the duct 258. In this manner, the baffle assemblies 203,204 advantageously control airflow and also efficiently prevent air from escaping the vacuum system 200. Additionally, it is within the scope of the disclosed concept for the baffle assemblies 203,204 to be adjustable or to be fixed to maintain a standard flow rate.

In operation, control over airflow is more critical for some locations on the conversion press 300. This is true, for example, for the portions coupled to the first and second branch assemblies 220,240. As such, the baffle assemblies 203,204 are located on the first and second branch assemblies 220,240, which are closer (in terms of distance that air travels) to the airflow generator 201 than the third and fourth branch assemblies 260,280. The vacuum system 200 has been described in association with two baffle assemblies 203,204. However, it will be appreciated that it is within the scope of the disclosed concept to include additional baffle assemblies (not shown), for example and without limitation, located on the third and fourth branch assemblies 260,280, or to not include one or both of the baffle assemblies 203,204, depending on the desired level of airflow (e.g., vacuum pressure) control.

The third branch assembly 260 includes a duct 278 that is coupled to and in fluid communication with the first and second portions 262,264 of the third branch assembly 260, and the fourth branch assembly 280 includes a duct 298 that is coupled to and in fluid communication with the first and second portions 282,284 of the fourth branch assembly 280. The primary duct 210, as well as the ducts 238,258,278,298, may be constructed of any material suitable for controlling airflow (e.g., without limitation, polyvinyl chloride (PVC), polyethylene, or polypropylene). Furthermore, the primary duct 210, as well as the ducts 238,258,278,298, are all preferably structured to have diameters larger than four inches. In the non-limiting example shown, the diameters are about six inches. In operation, the larger diameters correspond to significant reductions in pressure restrictions (e.g., line losses), within the vacuum system 200, which advantageously increases efficiency.

Referring to FIG. 6, the vacuum system 200 is shown as employed on a portion of the conversion press 300. The conversion press 300 includes a die assembly 310 having a lane die 312 and a number of die ports 348,350,368,370,388,390 on the lane die 312. Additionally, the conversion press 300 includes a pair of downstacker ports 328,330 located near a supply assembly 320. As will be discussed hereinbelow, the second portions 224,244,264,284 of the branch assemblies 220,240,260,280 are structured to be coupled to and be in fluid communication with the die ports 348,350,368,370,388,390 and the downstacker ports 328,330.

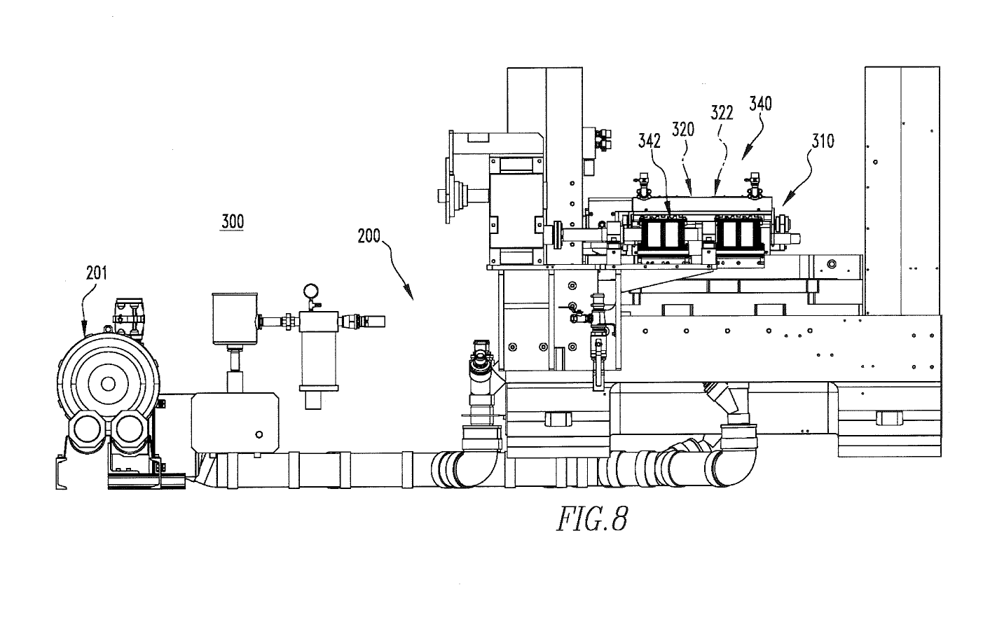

Continuing to refer to FIG. 6, the supply assembly 320 includes a downstacker 322 which operates to deliver shells (not shown) to the conversion press 300. The shells are moved through the conversion press 300 by a transfer assembly 340, which includes a pair of conveyor belts (not shown) and a vacuum manifold 342 (see FIG. 8) that is coupled to the die assembly 310. The conveyor belts include holes that receive and move the shells in a plane with respect to the die assembly 310, in a generally well known manner.

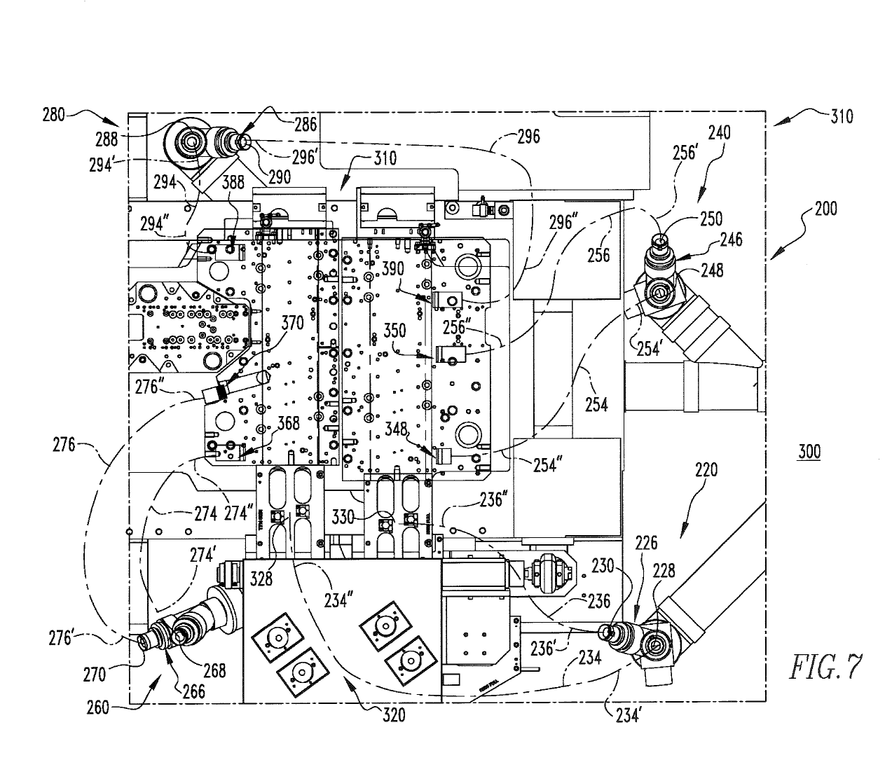

As seen in FIG. 7, which also shows the vacuum system 200 employed on the conversion press 300, the branch assemblies 220,240,260,280 each include a pair of conduits 234,236,254,256,274,276,294,296 (schematically shown) (e.g., without limitation, flexible hoses) that are respectively coupled to and are in fluid communication with the die ports 348,350,368,370,388,390 and the downstacker ports 328,330. For ease of illustration, the conduits 234,236,254,256,274,276,294,296 of the branch assemblies 220,240,260,280 are not shown in FIGS. 5, 6 and 8.

More specifically, referring to the first branch assembly 220, the first conduit 234 includes a first portion 234′ coupled to and in fluid communication with the first branch 228 of the airflow splitter member 226 and a second portion 234″ coupled to and in fluid communication with the downstacker port 328. In a similar manner, the second conduit 236 includes a first portion 236′ coupled to and in fluid communication with the second branch 230 of the airflow splitter member 226 and a second portion 236″ coupled to and in fluid communication with the downstacker port 330.

Continuing to refer to FIG. 7, the conduits 254,256 of the second branch assembly 240 include first portions 254′,256′ coupled to and in fluid communication with the first and second branches 248,250 of the airflow splitter member 246 and second portions 254″,256″ coupled to and in fluid communication with the die ports 348,350. Referring to the third branch assembly 260, the conduits 274,276 include first portions 274′,276′ that are coupled to and in fluid communication with the first and second branches 268,270 of the airflow splitter member 266 and second portions 274″,276″ that are coupled to and in fluid communication with the die ports 368,370.

Similarly, the conduits 294,296 of the fourth branch assembly 280 include first portions 294′,296′ that are coupled to and in fluid communication with the first and second branches 288,290 of the airflow splitter member 286 and second portions 294″,296″ that are coupled to and in fluid communication with die ports 388,390. In this manner, the single airflow generator 201 (FIGS. 5, 6 and 8) is able to deliver vacuum to the entire conversion press 300, advantageously eliminating the need for multiple airflow generators (not shown).

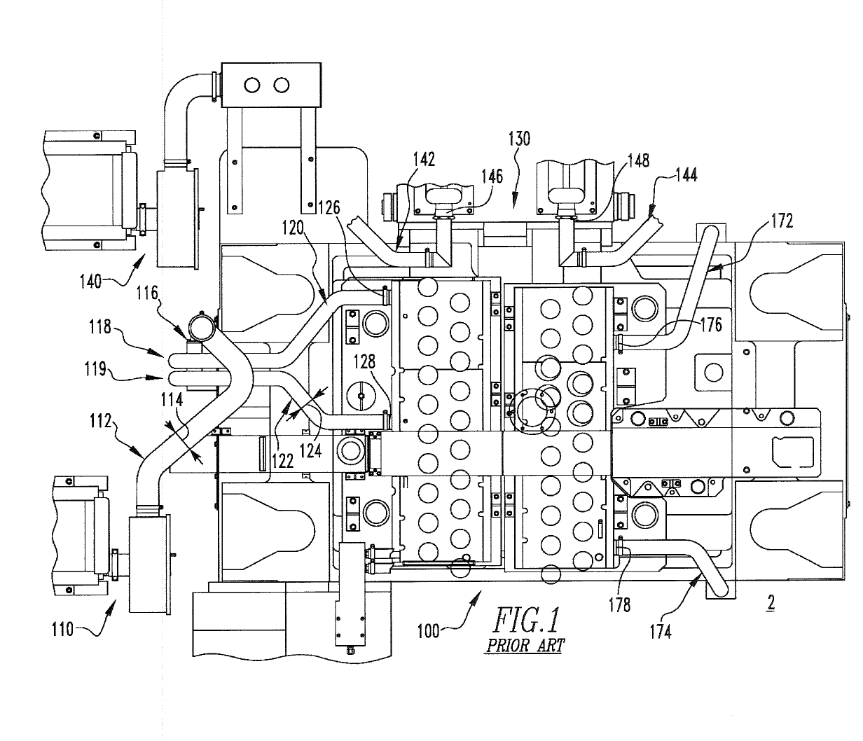

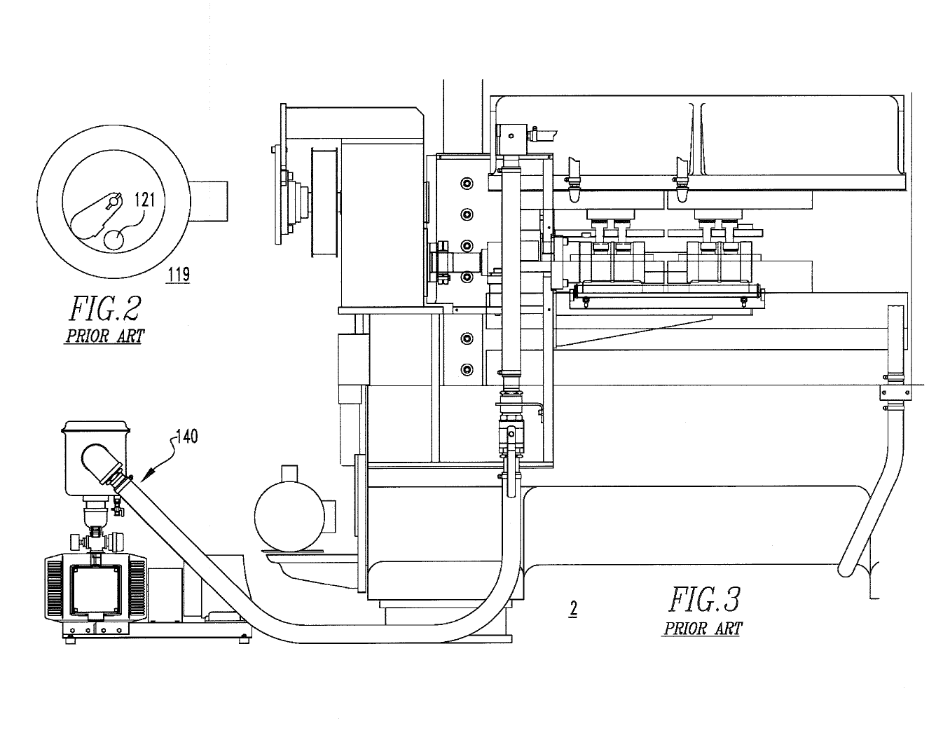

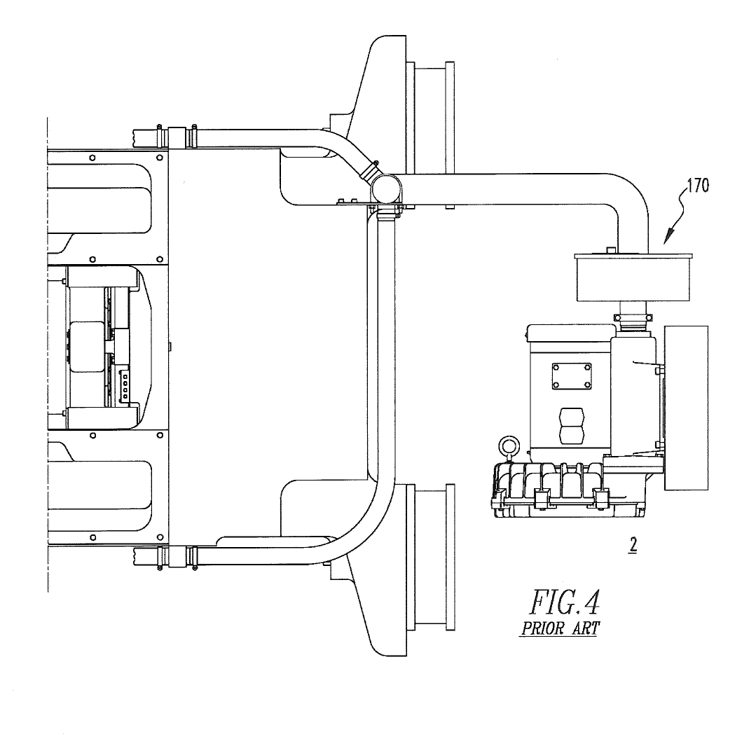

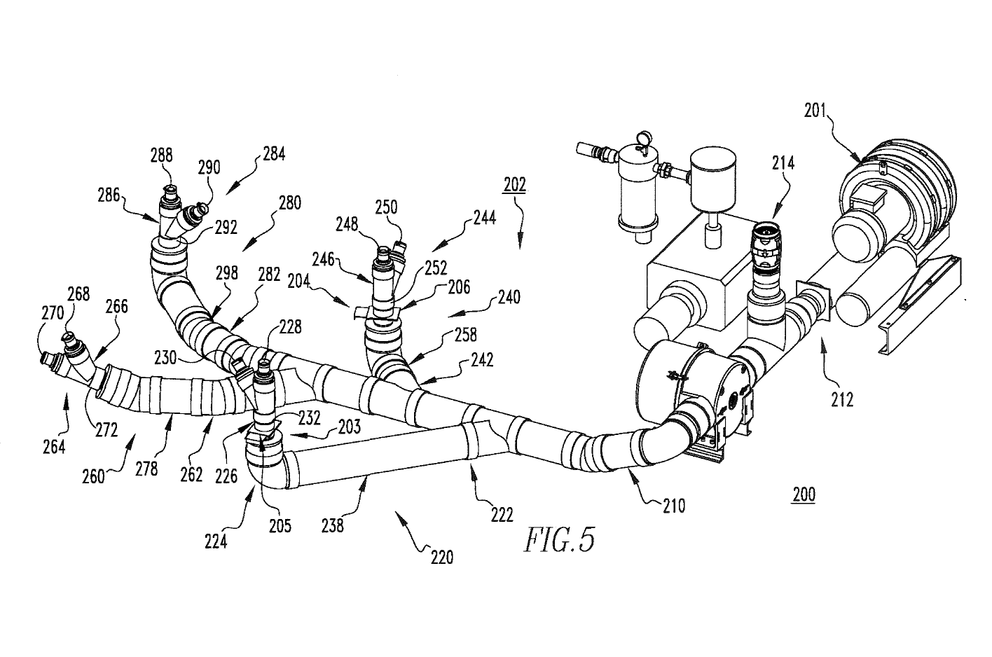

Benefits of the disclosed concept can readily be appreciated by comparing the conversion press 300, shown in FIGS. 6, 7 and 8, with the press system 2, shown in FIG. 1. Referring to FIG. 8, it will be appreciated that in operation, maintenance of conversion press 300 is significantly improved, as compared to the press system 2. For example and without limitation, only the single airflow generator 201 of the disclosed concept requires maintenance, as compared with the three airflow generators 110,140,170 of the press system 2. Additionally, the conversion press 300 has eight locations where vacuum is required, and as mentioned hereinabove, vacuum is delivered to all eight locations by the single airflow generator 201. By contrast, the press system 2 has only six locations where vacuum is required, and employs the three separate airflow generators 110,140,170 to deliver vacuum to these six locations.

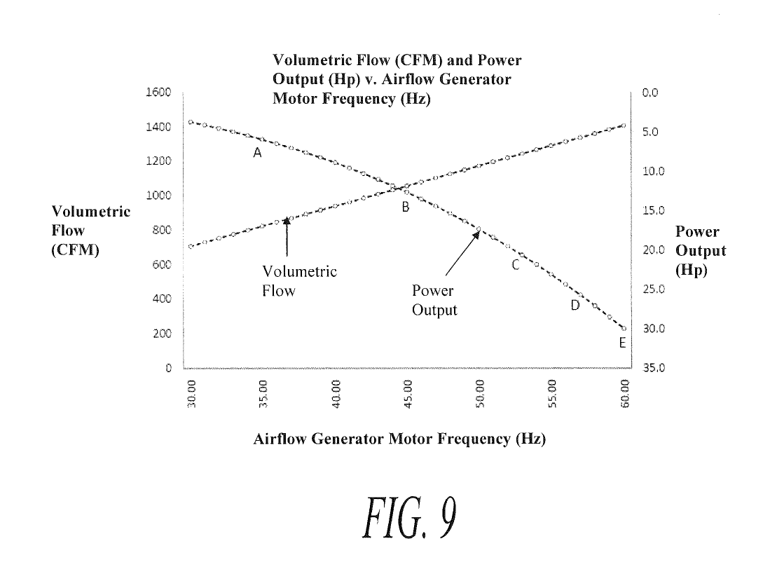

Moreover, the press system 2 typically requires 10 horsepower (Hp) for each of the airflow generators 110,140,170 to sufficiently deliver vacuum. By contrast, the single airflow generator 201 of the vacuum system 200 advantageously allows for a decrease in the overall power output, while still maintaining sufficient static pressure at each desired location on the conversion press 300. Referring to FIG. 9, the graph shows the power output and corresponding volumetric flow of the airflow generator 201 within the conversion press 300 when the airflow generator 201 is coupled to a variable frequency drive (not shown).

In operation, the conversion press 300 requires static vacuum pressure in the range of 7-20 inches of water column (inWC) at locations on the downstacker 322 and lane die 312. Table 1 below shows the static pressure measured at the downstacker 322 and lane die 312 at different power outputs along the graph shown in FIG. 9.

TABLE 1

| | Airflow | Volu- | | Downstacker | Lane Die |
|---|---|---|---|---|---|
| Graph 1 | Generator | metric | Power | Static | Static |
| Data | Motor | Flow | Output | Pressure | Pressure |
| Point | Frequency (Hz) | (CFM) | (Hp) | (in WC) | (in WC) |
| A | 35 | 823 | 6 | 7 | 9 |
| B | 45 | 1058 | 12.7 | 10 | 15 |
| C | 53 | 1246 | 20.7 | 11.5 | 17 |
| D | 57 | 1340 | 25.7 | 12.5 | 18.5 |
| E | 60 | 1410 | 30 | 13 | 19.5 |

As seen with reference to FIG. 9 and Table 1, the single airflow generator 201 is advantageously able to produce the required static pressure of 7-20 inWC at the downstacker 322 and lane die 312 at a lower overall total power output, corresponding to a significant reduction in energy consumption. For example and without limitation, employing with the single airflow generator 201 a 20 Hp motor will deliver sufficient vacuum to the entire conversion press 300, as opposed to employing three airflow generators 110,140,170, each with a 10 Hp motor. This corresponds to a 33% reduction in overall energy consumption.

Additionally, although the disclosed concept has been described in association with the conversion press 300 and the supply assembly 320 that delivers the shells, it is within the scope of the disclosed concept to employ the vacuum system 200, or a similar suitable alternative vacuum system (not shown), with other press systems (not shown). For example and without limitation, the vacuum system 200 or a similar suitable alternative vacuum system (not shown) may be employed with any press system (not shown) that employs vacuum at multiple locations to maintain a piece (not shown) being operated on.

Furthermore, although in a preferred embodiment the single airflow generator 201 is employed to deliver vacuum to all eight locations on the conversion press 300, it is within the scope of the disclosed concept to employ additional airflow generators (not shown). For example and without limitation, two airflow generators (not shown) may be employed with a vacuum system (not shown), each being structured to deliver vacuum to four locations on a press system (not shown).

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A vacuum system for a press system, the press system comprising a die assembly, a supply assembly, and a transfer assembly, the vacuum system comprising:
an airflow generator;
a duct assembly comprising:
a primary duct comprising a coupling segment coupled to and in fluid communication with the airflow generator, and
a plurality of branch assemblies, each comprising a first portion extending from and being in fluid communication with the primary duct, and a second portion structured to be in fluid communication with a corresponding portion of said press system; and
a number of baffle assemblies for controlling the airflow, each baffle assembly being disposed on one of the branch assemblies.

2. The vacuum system of claim 1 wherein the second portion of at least some of said branch assemblies comprises a splitter member including a first branch structured to be in fluid communication with a first portion of said press system and a second branch structured to be in fluid communication with a second, different portion of said press system.

3. The vacuum system of claim 2 wherein each of said baffle assemblies is disposed on said second portion of a corresponding one of said branch assemblies and is operable to direct and control airflow through said first branch to said first portion of said press system and to direct and control airflow through said second branch to said second, different portion of said press system.

4. The vacuum system of claim 3 wherein the second portion of said branch assembly further comprises a first conduit and a second conduit;
wherein the press system comprises a first port disposed proximate the first portion of the press system and a second port disposed proximate the second portion of the press system;
wherein the splitter member further includes a third branch structured to be in fluid communication with said first baffle assembly;
wherein the first conduit comprises a first portion coupled to and in fluid communication with the first branch of the splitter member, and a second portion;
wherein the second conduit comprises a first portion coupled to and in fluid communication with the second branch of the splitter member, and a second portion;
wherein the second portion of the first conduit is coupled to and in fluid communication with the first port; and
wherein the second portion of the second conduit is coupled to and in fluid communication with the second port.

5. The vacuum system of claim 1 wherein the primary duct further comprises a check valve disposed proximate the coupling segment of the primary duct.

6. The vacuum system of claim 1 wherein the airflow generator consists of a single regenerative blower.

7. The vacuum system of claim 1 wherein at least some of said branch assemblies further comprise a secondary duct coupled to and in fluid communication with the corresponding first and second portions of said at least some of said branch assemblies; and wherein the primary and secondary ducts are constructed of a material selected from the group consisting of polyvinyl chloride, polyethylene, and polypropylene.

8. The vacuum system of claim 1 wherein the plurality of branch assemblies comprises a first branch assembly, a second branch assembly, a third branch assembly, and a fourth branch assembly.

9. The vacuum system of claim 8 wherein the first portion of the first branch assembly and the first portion of the second branch assembly are closer to the airflow generator than the first portion of the third branch assembly and the first portion of the fourth branch assembly; wherein said number of baffle assemblies includes a first baffle assembly and a second baffle assembly; and wherein said first baffle assembly is disposed on said second portion of said first branch assembly and said second baffle assembly is disposed on said second portion of said second branch assembly.

10. The vacuum system of claim 9 wherein the transfer assembly comprises a conveyor belt and a vacuum manifold coupled to the die assembly, the conveyor belt including a plurality of holes and being structured to receive and move a plurality of shells in a plane with respect to the die assembly; wherein the die assembly comprises a first die port, a second die port, a third die port, a fourth die port, a fifth die port, and a sixth die port; and wherein the supply assembly comprises a first downstacker port and a second downstacker port;
wherein the first branch assembly comprises a first conduit having a first portion coupled to and in fluid communication with the first downstacker port and a second portion coupled to and in fluid communication with the first baffle assembly;
wherein the first branch assembly further comprises a second conduit having a first portion coupled to and in fluid communication with the second downstacker port and a second portion coupled to and in fluid communication with the first baffle assembly;
wherein the second branch assembly comprises a first conduit having a first portion coupled to and in fluid communication with the first die port and a second portion coupled to and in fluid communication with the second baffle assembly;
wherein the second branch assembly further comprises a second conduit having a first portion coupled to and in fluid communication with the second die port and a second portion coupled to and in fluid communication with the second baffle assembly;
wherein the third branch assembly comprises a first conduit having a first portion coupled to and in fluid communication with the third die port and a second portion in fluid communication with the first portion of the third branch assembly;
wherein the third branch assembly further comprises a second conduit having a first portion coupled to and in fluid communication with the fourth die port and a second portion in fluid communication with the first portion of the third branch assembly;
wherein the fourth branch assembly comprises a first conduit having a first portion coupled to and in fluid communication with the fifth die port and a second portion in fluid communication with the first portion of the fourth branch assembly; and
wherein the fourth branch assembly further comprises a second conduit having a first portion coupled to and in fluid communication with the sixth die port and a second portion in fluid communication with the first portion of the fourth branch assembly.

11. A press system comprising:
a die assembly;
a supply assembly;
a transfer assembly comprising a conveyor belt and a vacuum manifold coupled to the die assembly; and
a vacuum system comprising:
an airflow generator;
a duct assembly comprising:
a primary duct comprising a coupling segment coupled to and in fluid communication with the airflow generator, and
a plurality of branch assemblies, each comprising a first portion extending from and being in fluid communication with the primary duct, and a second portion structured to be in fluid communication with a corresponding portion of said press system; and
a number of baffle assemblies for controlling the airflow, each baffle assembly being disposed on one of the branch assemblies.

12. The press system of claim 11 wherein the second portion of at least some of said branch assemblies comprises a splitter member including a first branch structured to be in fluid communication with a first portion of said press system and a second branch structured to be in fluid communication with a second, different portion of said press system.

13. The press system of claim 12 wherein each of said baffle assemblies is disposed on said second portion of a corresponding one of said branch assemblies and is operable to direct and control airflow through said first branch to said first portion of said press system and to direct and control airflow through said second branch to said second, different portion of said press system.

14. The press system of claim 13 wherein the second portion of said branch assembly further comprises a first conduit and a second conduit;
wherein the press system comprises a first port disposed proximate the first portion of the press system and a second port disposed proximate the second portion of the press system;
wherein the splitter member further includes a third branch structured to be in fluid communication with said first baffle assembly;
wherein the first conduit comprises a first portion coupled to and in fluid communication with the first branch of the splitter member, and a second portion;
wherein the second conduit comprises a first portion coupled to and in fluid communication with the second branch of the splitter member, and a second portion;
wherein the second portion of the first conduit is coupled to and in fluid communication with the first port; and
wherein the second portion of the second conduit is coupled to and in fluid communication with the second port.

15. The press system of claim 11 wherein the primary duct further comprises a check valve disposed proximate the coupling segment of the primary duct.

16. The press system of claim 11 wherein the airflow generator consists of a single regenerative blower.

17. The press system of claim 11 wherein at least some of said branch assemblies further comprise a secondary duct coupled to and in fluid communication with the corresponding first and second portions of said at least some of said branch assemblies; and wherein the primary and secondary ducts are constructed of a material selected from the group consisting of polyvinyl chloride, polyethylene, and polypropylene.

18. The press system of claim 11 wherein the plurality of branch assemblies comprises a first branch assembly, a second branch assembly, a third branch assembly, and a fourth branch assembly.

19. The press system of claim 18 wherein the first portion of the first branch assembly and the first portion of the second branch assembly are closer to the airflow generator than the first portion of the third branch assembly and the first portion of the fourth branch assembly; wherein said number of baffle assemblies includes a first baffle assembly and a second baffle assembly; and wherein said first baffle assembly is disposed on said second portion of said first branch assembly and said second baffle assembly is disposed on said second portion of said second branch assembly.

20. The press system of claim 19 wherein the press system is a conversion press; wherein the die assembly comprises a plurality of dies, a first die port, a second die port, a third die port, a fourth die port, a fifth die port, and a sixth die port; wherein the dies include a plurality of tool stations; wherein the conveyor belt includes a plurality of holes and is structured to receive and move a plurality of shells in a plane with respect to the die assembly; wherein the conveyor belt moves the shells with respect to the dies in order that the tool stations progressively form the shells into completed can ends; wherein the supply assembly comprises a first downstacker port and a second downstacker port;
wherein the first branch assembly comprises a first conduit having a first portion coupled to and in fluid communication with the first downstacker port and a second portion coupled to and in fluid communication with the first baffle assembly;
wherein the first branch assembly further comprises a second conduit having a first portion coupled to and in fluid communication with the second downstacker port and a second portion coupled to and in fluid communication with the first baffle assembly;
wherein the second branch assembly comprises a first conduit having a first portion coupled to and in fluid communication with the first die port and a second portion coupled to and in fluid communication with the second baffle assembly;
wherein the second branch assembly further comprises a second conduit having a first portion coupled to and in fluid communication with the second die port and a second portion coupled to and in fluid communication with the second baffle assembly;
wherein the third branch assembly comprises a first conduit having a first portion coupled to and in fluid communication with the third die port and a second portion in fluid communication with the first portion of the third branch assembly;
wherein the third branch assembly further comprises a second conduit having a first portion coupled to and in fluid communication with the fourth die port and a second portion in fluid communication with the first portion of the third branch assembly;
wherein the fourth branch assembly comprises a first conduit having a first portion coupled to and in fluid communication with the fifth die port and a second portion in fluid communication with the first portion of the fourth branch assembly; and
wherein the fourth branch assembly further comprises a second conduit having a first portion coupled to and in fluid communication with the sixth die port and a second portion in fluid communication with the first portion of the fourth branch assembly.
